(19) United States
(12) Patent Application Publication
(10) Pub. No.: US 2007/0190403 A1
(43) Pub. Date: Aug. 16, 2007

(54) DEVICE FOR DETECTING ELECTROLYTE OVERFLOW AND ENERGY STORAGE DEVICE HAVING THE SAME

(76) Inventor: Chin-Ho Wang, Sansia Township (TW)

Correspondence Address: RABIN & Berdo, PC, 1101 14TH STREET, NW, SUITE 500, WASHINGTON, DC, 20005, US

(21) Appl. No.: 11/733,864

(22) Filed: Apr. 11, 2007

(30) Foreign Application Priority Data
Jun. 14, 2005 (TW) 095121291

(51) Int. Cl. H01M 2/00

(52) U.S. Cl. 429/63

(57) ABSTRACT

A device for detecting an electrolyte overflow is provided, which includes an overflow detecting portion selectively disposed on a carrier. Once the overflow detecting portion contacts with the overflowed electrolyte, an impedance of the overflow detecting portion is changed. Through the change of the impedance, when the electrolyte overflows, an electronic signal is generated by the detection of an electronic circuit. With the electronic signal, the electronic circuit connected to the device is cut off through a protective circuit, so as to prevent the electronic circuit from continuously operating and causing damages to the electronic circuit or the device/system.

This non-provisional application claims priority under 35 U.S.C. § 119(a) on Patent Application No(s). 095121291 filed in Taiwan, R.O.C. on Jun. 14, 2006, the entire contents of which are hereby incorporated by reference.

### BACKGROUND OF THE INVENTION

1. Field of Invention

The present invention relates to a device for detecting a chemical fluid. More particularly, the present invention relates to a device applied to a device having an electrolyte, for example, a cell or a capacitor, etc., for detecting the electrolyte overflow in the device.

2. Related Art

As the rapid development of science and technology, various devices emphasizing a portable function have been increasingly increased, for example, cell phones, notebook computers, and personal digital assistants (PDAs). Currently, digital cinema projectors and digital cameras also increasingly emphasize the portable function. All the portable electronic products need a high density electrical energy storage device for operation. However, usually, due to defects of the products or the unsuitable usage, accidents such as combustion or explosion occur.

Generally, a protective circuit is used to solve the above problem, such that the technical means disclosed in “RECHARGEABLE CELL PROTECTING DEVICE” of ROC Patent Publication No. M275625, “CELL PROTECTING DEVICE” of ROC Patent Publication No. M246883, and “BATTERY SET PROTECTING CIRCUIT” of ROC Patent Publication No. 497313. However, as for the current device for protecting the electrolytic cell, the protective loop is only designed for the electronic circuit within the cell, such that when the voltage or the current overloads, the circuit is cut off, for protection.

Although such a protective circuit can reduce a part of the accidents, defects still exist. For example, when the cell or the capacitor is abnormal and the electrolyte overflows, the response at the voltage or current is not significant. At this time, the common detecting circuit cannot detect such an abnormal situation, and the user cannot perceive it as well. At this time, if the defective product is continuously used, the accidents such as explosion or combustion may occur. However, recently, no effective solution for the above situation is proposed.

In addition, the fixed uninterruptible power system is required to prolong the run time after the power failure and to instantly recover the power supply, such that it utilizes a large-scale cell for power storage. Once the energy storage devices are abnormal, the electrolyte usually overflows to cause the fire hazard, combustion, or explosion, which puts the human life, the factory building, and the living facility into danger.

Therefore, a technique for detecting an electrolyte overflowing state of the device having the electrolyte becomes an important issue for the current technical development.

### SUMMARY OF THE INVENTION

Accordingly, the present invention provides a device for detecting an electrolyte overflow, so as to solve the problems of the prior art.

According to an embodiment of the present invention, the device for detecting the electrolyte overflow includes an overflow detecting portion. The overflow detecting portion is formed on the carrier, and once the overflow detecting portion contacts with the overflowed electrolyte, the impedance of the overflow detecting portion is changed.

The present invention further provides an energy storage device having an electrolyte overflow detecting portion, which includes an energy storage module and a device for detecting an electrolyte overflow. The energy storage module has an electrolyte to electrochemically store the energy. The device for detecting the electrolyte overflow has an overflow detecting portion, and once the overflow detecting portion contacts with the overflowed electrolyte, the impedance of the overflow detecting portion is changed.

According to the above-mentioned embodiment of the present invention, the carrier of the overflow detecting portion is a plastic sheet, a cloth, a polymer, or a paper sheet.

According to the above-mentioned embodiment of the present invention, the device for detecting the electrolyte overflow further includes a pair of wires, connected to the overflow detecting portion, for outputting the impedance change of the overflow detecting portion.

According to the above-mentioned embodiment of the present invention, the device for detecting the electrolyte overflow further includes a detecting circuit, connected to the wires, for outputting an electronic signal in response to the impedance change.

According to the embodiments provided by the present invention, if the electrolyte in the cell or the electrolytic capacitor overflows, through the impedance change of the detecting device, an electronic signal is generated by the detection of an electronic circuit. With the electronic signal, the electronic circuit connected to the device is cut off through a protective circuit, so as to prevent the electronic circuit from continuously operating and causing damages to the electronic circuit or the device/system.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1A is a schematic structural view of a device for detecting an electrolyte overflow according to the present invention; and

FIG. 1B is another schematic structural view of a device for detecting an electrolyte overflow according to the present invention; and

FIG. 2 is a circuit diagram of a detecting circuit used together with the device for detecting the electrolyte overflow according to the present invention.

### DETAILED DESCRIPTION OF THE INVENTION

The detailed features and advantages of the present invention are described below in great detail through the following embodiments, the content of the detailed description is sufficient for those skilled in the art to understand the technical content of the present invention and to implement the present invention there accordingly. Based upon the content of the specification, the claims, and the drawings, those skilled in the art can easily understand the relevant objectives and advantages of the present invention.

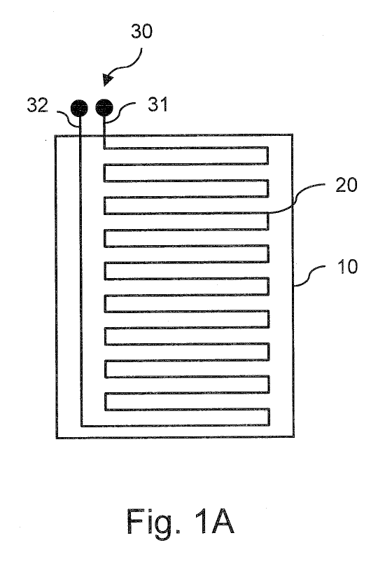

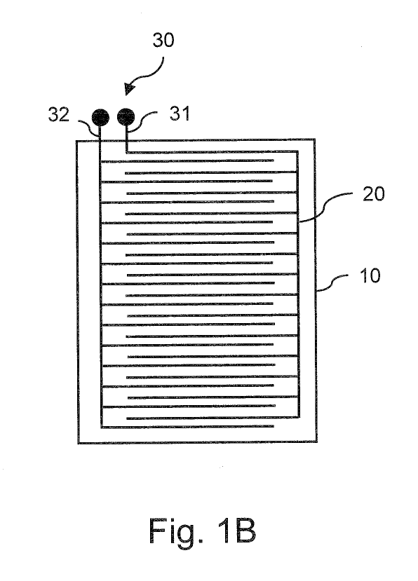

Referring to FIG. 1A, it is a schematic structural view of a device for detecting an electrolyte overflow according to the present invention. The device for detecting the electrolyte overflow is mainly applied to an energy storage device, for example, an electrolytic cell or an electrolytic capacitor.

The device for detecting the electrolyte overflow is mainly formed by an overflow detecting portion 20 that is selectively disposed on a first carrier 10. The device for detecting the electrolyte overflow may be attached or adhered to the outside of the body of the electrolytic cell or the electrolytic capacitor. Once the overflow detecting portion 20 contacts with the electrolyte overflowed out of the electrolytic cell or the electrolytic capacitor, the impedance of the overflow detecting portion 20 is changed.

In order to make the impedance change be detected by a circuit after it occurs, the overflow detecting portion 20 is connected to a pair of wires 30, including wires 31 and 32 connected with a detecting circuit. Therefore, once the impedance of the overflow detecting portion 20 is changed, the detecting circuit (which will be described below) connected to the wires 30 may change the impedance-changing state into a voltage-type or current-type electrical power signal for being outputted.

In using, the embodiment in FIG. 1 is made to contact with an energy storage device having an electrolyte, which may be, for example, a cell, a capacitor, or a generator using a liquid fuel, etc.

The first carrier 10 can be a plastic sheet, a cloth, a polymer, or a paper sheet. The criteria for the selection of the material lies in that, the material can tolerate the change of the overflow detecting portion 20 and it is not chemically reacted with the electrolyte. The overflow detecting portion 20 is carried by a sheet-shaped carrier, so the device for detecting the electrolyte overflow of the present invention can be directly attached to the body of the cell or the capacitor. However, the first carrier 10 is not necessary, which can be omitted as long as the material of the overflow detecting portion 20 is properly selected.

The change of the impedance occurs once the overflow detecting portion 20 contacts with the overflowed electrolyte. The arranging mode may be one line, two uncrossed lines, or two upper and lower thin films that are not contacted with each other. For example, it may be one line as shown in the figure. FIG. 1B is another embodiment illustrating the overflow detecting portion 20 is in the form of two uncrossed lines. In FIG. 1A, the impedance of the overflow detecting portion 20 increases when the overflow detecting portion 20 contacts with the overflowed electrolyte; while in FIG. 1B, that of the overflow detecting portion 20 decreases.

As for the material of the overflow detecting portion 20, the test paper or the test cloth with a different material may be selected as the tool for detecting the electrolyte leakage of the cell module. The principle mainly lies in that, the electrolyte is adsorbed on the surface of the test paper or the test cloth, and once the resistance value is changed, a signal is detected.

The material of the selected test paper or test cloth has a very large resistance value in the dry state, for example, from kilo ohm to over mega ohm. However, if the electrolyte is adsorbed thereon, the resistance value is sharply reduced to lower than mega ohm.

The following table shows the change of the resistance value when the test paper or the test cloth, for detecting the leakage of the electrolyte, made of a different material is under the dry state and when the test paper or the test cloth has the electrolyte adsorbed thereon.

| | Impedance in the Dry | Impedance after the |
|---|---|---|
| Material | State | Electrolyte is Adsorbed |
| PH Test Paper | Larger than kilo ohm | Smaller than kilo ohm |
| 3M Non-woven Fabric | Larger than mega ohm | Smaller than mega ohm |
| Common Paper | Larger than mega ohm | Smaller than mega ohm |

Under the circumstance that the adopted test paper or test cloth has diffusibility and permeability features, and its resistance value under the dry state is larger than kilo or mega ohm, since the electrolyte has a high conductivity, once it is adsorbed on the test paper or the test cloth, a signal is generated due to the sharp change of the impedance, and thus, such a test paper or test cloth can be used as the material for detecting the leakage of the electrolyte. As long as the electrical impedance value for any test paper or test cloth is changed as the test paper or test cloth is changed from the dry state to a state with the electrolytic adsorbed thereon, such a test paper or test cloth can be used as the material for detecting the leakage of the electrolyte.

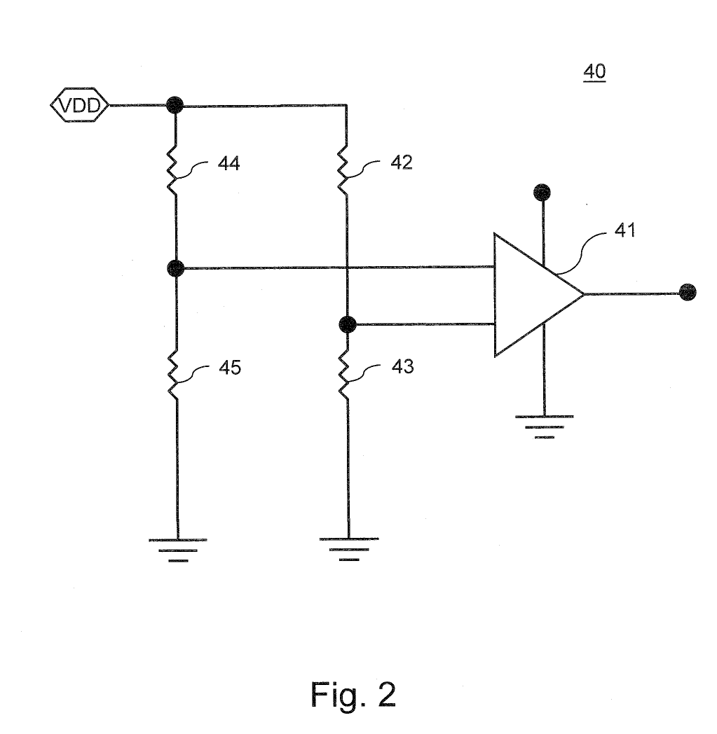

Referring to FIG. 2, it is an embodiment of a detecting circuit, which is used for changing the impedance-changing state to the voltage or current signal for being outputted, once the impedance of the overflow detecting portion 20 is changed. The detecting circuit 40 is mainly formed by a comparator 41 with two input ends being respectively connected to the wires 31 and 32. In additional, some resistors required by the operation of the circuit still exist, for example, resistors 42, 43, 44, and 45. Once the impedance of the overflow detecting portion 20 is changed, the overflow detecting portion 20 can be connected to any position of the resistors 42, 43, 44, and 45 through the connection of the wires 31 and 32 and the resistors 42, 43, 44, and 45. Since the impedance change occurs for the detecting portion 20, the comparator 41 senses the change of the voltage with the two input ends, and outputs an electronic signal with the output end.

The detecting circuit shown in FIG. 2 may be disposed on a second carrier (not shown). In one embodiment, the second carrier may be a soft printed circuit board (PCB). In another embodiment, the overflow detecting portion 20 and the detecting circuit can be disposed on the same carrier.

The comparator 41 is connected to a protective circuit (not shown) at the output end. A switch controlled by the electronic signal may be disposed in the protective circuit, for example, MOSET, or a protective element such as fuse may be disposed therein. When the electronic signal outputted by the comparator 41 indicates that the impedance of the overflow detecting portion 20 is changed, it means that the electrolyte overflows. At this time, the operation of the system may be cut off through the function of the protective circuit. For example, after the impedance is changed, the comparator 41 converts the change into a voltage-type electronic signal, so as to control the switch. If the energy storage device or the capacitor is connected to an electronic circuit or a power source, upon receiving the signal about the impedance change, the switch immediately cuts off the closed circuit of the energy storage device or the capacitor and thus forming an open circuit, so as to avoid accidents.

As for the embodiments shown in FIGS. 1 and 2, the energy storage device or the capacitor is made to contact with the device for detecting the electrolyte overflow of the present invention during fabrication. When the electrolyte overflows out of the energy storage device or the capacitor, it immediately contacts with the overflow detecting portion of the device for detecting the electrolyte overflow. The overflow detecting portion is chemically reacted with the electrolyte, and then, the resistance is changed after the chemical reaction occurs, which is outputted by the wires. Different voltage signals are sent out by the comparator in the detecting circuit under the normal state and the abnormal state respectively.

The embodiments shown in FIGS. 1 and 2 may be integrally formed into a configuration of a suite during fabrication, which is convenient for the user to directly adhere on the energy storage device or the capacitor. In another embodiment, the embodiments shown in FIGS. 1 and 2 are separated parts, that is, the detecting circuit and the protective circuit may be designed to be formed together with the circuit of an external system, and thus, the user only needs to directly adhere the device for detecting the electrolyte overflow on the energy storage device or the capacitor.

According to the embodiments provided by the present invention, a chemical component with a special composition is used, and particularly, once the chemical component contacts with the electrolyte, the impedance thereof is changed. Through the change of the impedance, when the electrolyte in the device overflows, an electronic signal is generated by the detection of the electronic circuit. With the electronic signal, the electronic circuit connected with the device is cut off through the protective circuit, so as to prevent the electronic circuit from continuously operating and causing damages to the electronic circuit or the device/system.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A device for detecting an electrolyte overflow, comprising:
an overflow detecting portion, wherein once the overflow detecting portion contacts with the overflowed electrolyte, an impedance of the overflow detecting portion is changed.

2. The device for detecting the electrolyte overflow as claimed in claim 1, further comprising a first carrier, wherein the overflow detecting portion is arranged on the first carrier.

3. The device for detecting the electrolyte overflow as claimed in claim 2, wherein the first carrier is one selected from a group consisting of a plastic sheet, a cloth, a polymer, a non-woven cloth, and a paper sheet.

4. The device for detecting the electrolyte overflow as claimed in claim 1, further comprising a pair of wires, connected to the overflow detecting portion, for outputting an electrical power signal in response to the impedance change of the overflow detecting portion.

5. The device for detecting the electrolyte overflow as claimed in claim 4, further comprising a detecting circuit, connected to the pair of wires, for outputting an electrical power signal in response to the impedance change.

6. The device for detecting the electrolyte overflow as claimed in claim 5, further comprising a second carrier, wherein the detecting circuit is placed on the second carrier.

7. The device for detecting the electrolyte overflow as claimed in claim 5, further comprising a switch, for changing an ON/OFF state in response to the electrical power signal outputted by the detecting circuit.

8. The device for detecting the electrolyte overflow as claimed in claim 5, further comprising a carrier, wherein the overflow detecting portion and the detecting circuit are arranged on the carrier.

9. The device for detecting the electrolyte overflow as claimed in claim 8, wherein the carrier is one selected from a group consisting of a plastic sheet, a cloth, a polymer, a non-woven cloth, and a paper sheet.

10. An energy storage device, comprising:
an energy storage module, having an electrolyte to electrochemically store the energy; and
a detecting device for detecting an electrolyte overflow, contacting with the energy storage module, comprising an overflow detecting portion, wherein once the overflow detecting portion contacts with the overflowed electrolyte of the energy storage module, the impedance of the overflow detecting portion is changed.

11. The energy storage device as claimed in claim 10, further comprising a first carrier, wherein the overflow detecting portion is arranged on the first carrier.

12. The energy storage device as claimed in claim 11, wherein the carrier is one selected from a group consisting of a plastic sheet, a cloth, a polymer, a non-woven cloth, and a paper sheet.

13. The energy storage device as claimed in claim 10, further comprising a pair of wires, connected to the overflow detecting portion, for outputting an electrical power signal in response to the impedance change of the overflow detecting portion.

14. The energy storage device as claimed in claim 13, further comprising a detecting circuit, connected to the pair of wires, for outputting an electrical power signal in response to the impedance change.

15. The energy storage device as claimed in claim 14, further comprising a second carrier, wherein the detecting circuit is placed on the second carrier.

16. The energy storage device as claimed in claim 14, further comprising a switch, for changing an ON/OFF state in response to the electrical power signal outputted by the detecting circuit.

17. The energy storage device as claimed in claim 14, further comprising a carrier, wherein the overflow detecting portion and the detecting circuit are arranged on the carrier.

18. The energy storage device as claimed in claim 17, wherein the carrier is one selected from a group consisting of a plastic sheet, a cloth, a polymer, a non-woven cloth, and a paper sheet.
